(19) United States
(12) Patent Application Publication
(10) Pub. No.: US 2023/0023355 A1
(43) Pub. Date: Jan. 26, 2023

(54) CONFORMAL VEST VENTILATOR

(71) Applicants: COLIN FELTON, COOS BAY, OR (US); ROBERT FAULKNER, 28461, NC (US); ROGER FAULKNER, DAVIDSON, NC (US)

(72) Inventors: COLIN FELTON, COOS BAY, OR (US); ROBERT FAULKNER, 28461, NC (US); ROGER FAULKNER, DAVIDSON, NC (US)

(21) Appl. No.: 17/781,662

(22) PCT Filed: Apr. 12, 2020
(86) PCT No.: PCT/US2020/063348

§ 371 Date: Jun. 1, 2022

(51) Int. Cl. A61H 31/00; A61H 9/00; A61H 23/02

(52) U.S. Cl. CPC A61H 31/00; A61H 9/0092; A61H 23/0245; A61H 2201/1621; A61H 2201/165; A61H 2031/001; A61H 2031/002; A61H 2023/0227

(57) ABSTRACT

The Conformal Vest Ventilator (CVV) is a vest-like mechanism to cause or aid breathing in humans The Conformal Vest Ventilator consists of a series of expanding and contracting tubes that fit around the torso, similar to clothing, and which change shape in a manner that expands the thoracic cavity to create negative pressure ventilation in the lungs, similar to the natural ventilation created by the diaphragm muscle and the expanding rib cage. The CVV creates a breathing support system that is less intrusive than existing methods, and can improve the lives of people with COPD or paralyzed diaphragm muscles and is useful in other medical conditions, including sleep apnea, critical care, spinal cord injuries, and athletic training or physical therapy when the primary goal is to increase lung capacity.

### SUMMARY

The CVV is based upon expandable, elongating, actuated structural elements which surround at least a portion of the thoracic cavity. For consistency within this document, we will refer to these elements as “lengthening mechanical elements.”

Connection must be maintained between the CVV and the body. Connection could be via reversible adhesives or an isolated air cushion surrounding the torso and inside the CVV device, so that a mild vacuum exists around the thoracic cavity during inhalation, or by other means.

Said vacuum can either be a continuous vacuum maintained by a vacuum pump, or a temporary vacuum that occurs only during inhalation. Said temporary vacuum could be caused by the expansion of the CVV around the torso. In either case, the gas pressure under the CVV will go down during the inhalation cycle.

In the case of a gas layer which is always at a pressure below atmospheric pressure around the torso, the maximum vacuum relative to local atmospheric pressure in that layer must be limited to avoid bruising. The safe level of the vacuum will vary from individual to individual and is affected by many factors including taking aspirin for example. Typically, such a constant vacuum should not be more than 5% of atmospheric pressure or approximately 5000 Pa below the surrounding atmospheric pressure.

The gas volume between the low-permeability layer in the CVV and the skin may be different for different designs. Preferably, the volume of air between the patient's skin and the low gas permeability layer of the CVV should be no more than one tenth the volume of air that exists under a typical cuirass ventilator.

In the conformal version of the CVV most of the air under the vest is interstitial between the fibers of a fabric layer.

It is also possible to have a pocket of air under the vest which decouples the skin from the vest while still allowing the actuation of inhalation through the vacuum surrounding the thoracic cavity. In this mode the CVV can be thought of as a flexible cuirass ventilator but differs from prior art flexible cures ventilators and that it is the deformation of the flexible vest per se that causes breathing.

In the versions of the invention in which there is a large enough air bubble under the vest to decouple the skin from the vast, the best portion of the CVV nearly conforms to the shape of the body, and inhalation is driven by the shape change of the vest as opposed to a zone where air is introduced and removed through a tube as in the cuirass ventilator.

One-way valves that expel air during the contraction of the vest, but which hold the vacuum during expansion of the vest can create the necessary vacuum.

Alternatively, a special engineered elastomeric sheet which has a higher permeability in one direction than in the opposite direction can be used to create the vacuum needed around the torso and beneath the vest during the inhalation cycle. Said specially engineered elastomeric sheet may have slits at an angle through the elastomeric sheet with a small wedge of rubber removed on only one side of the slit. Such an elastomeric sheet will resist flow in one direction, but it opens when a pressure differential is applied in the other direction.

The method used to create a vacuum attachment of the CVV to the torso may also comprise suction cups that stick against the body.

Expansion of the CVV may be powered by any means that can create the desired shape change in the lengthening mechanical elements including anisotropic elastomeric inflatable tubes in the wall of the vest, or electromechanically driven components of the CVV such as can be created with electromagnetic linear drivers, piezoelectric components, or magnetostrictive alloys for example. Said drivers may also include linear actuators which are linked to a framework around the thoracic cavity.

In a preferred version of the CVV, the inhalation and exhalation cycle are driven by structural elements that lengthen and shorten in the vest itself. These lengthening mechanical elements are incorporated into a vest that fits around the thoracic cavity of a patient needing respiratory support or for any other purpose which may include an effort to increase lung capacity. Said lengthening mechanical elements get longer when they are stimulated. That stimulation can occur through a change in fluid pressure, through flow of an electric current, or a change in electrical potential.

The vest may contract to help exhalation of air as well as inhalation. Said contraction may be through an elastic contraction of the inflatable tubes which follows the expansion, caused by removing fluid from inside said tubes, or by a separate means embedded into the vest. In the case of an electrically actuated motion lengthening mechanical elements within the vest causing the expansion and contraction of the vest, this same mechanism may be used to cause the contraction.

Alternatively, contraction can be created by a separate mechanism that is different from the mechanism which powered the lengthening of the mechanical elements during the inhalation cycle. Said mechanism to power the exhalation cycle may comprise a second type of inflatable tube that gets shorter when the tube is pressurized, or a muscle wire for example.

Elastic retraction of the vest is like the lung elasticity which normally causes exhalation, but which is deficient among COPD patients.

It is possible to apply a pressure change inside anisotropic elastomer tubes in the vest to cause both the inhalation vacuum and the exhalation pressure inside the CVV. This option enables the complete breathing cycle to be powered by the same mechanism. Said anisotropic elastomer tubes will last longer if they do not cycle through zero strain during the breathing cycle deformations.

This operational method of maintaining positive inflation pressure inside the anisotropic inflatable tubes at all times could potentially cause squeezing of the lungs during certain kinds of accidents such as leakage of the fluid from the anisotropic inflatable tubes or from the manifold which delivers fluid to and from said anisotropic elastomer tubes. Because of this, it may be desirable to actuate exhalation via contraction of the anisotropic tubes to their zero elastic stress state. Such an exhalation cycle avoids the possibility that in some sort of malfunction the vest would be squeezing the patient.

In the case that exhalation is powered by contraction of the anisotropic elastomer tubes to their zero stress rest state, there would be a contraction around the pneumothorax, but even if hydraulic fluid is lost the contraction of the CVV would not be so severe as to prevent at least shallow inhalation.

For patients who need positive pressure on the thorax during exhalation due to a loss of elasticity of the lungs, it may be desirable that there be a stronger contraction around the thorax than can be accomplished by the inflatable tubes returning only to their rest state. For this case, which corresponds to severe COPD, it is desirable that the end of the exhalation cycle corresponds to an elastically stressed state in the anisotropic elastomer tubes driving the expansion and contraction of the CVV.

Versions of the device will be useful in emergency situations including battlefield injuries and automobile accidents. The ability to apply the ventilator around the torso could be useful to allow medical access to the head and will produce less distress for many injured patients who want to speak.

For the lengthening mechanical elements to create the desired vacuum inside the CVV, the elements must have an outward-facing curvature surrounding the thoracic cavity. For some people, this may make it impossible for the inflatable anisotropic tubes to follow the body's curvature, and may require a gap between a portion of a person's torso and the outward convex curvature of the CVV structural elements surrounding the thoracic cavity.

One embodiment of this idea which addresses the issue of a concave body shape in some areas is to allow for separation between the CVV and some part of the skin surrounding the thoracic cavity. In this case, the deformation of the vest causes the inhalation through and isolated air pocket line between the vest and the skin. In this mode of operation there is no need for the vest to follow the contours of the body. This may also be more comfortable.

The effective pressure under the vest has one component which is caused by the gas pressure differential between gas pressure inside the vest and outside vest, and another component which is the pressure against the torso delivered by mechanical contact between the vest and the skin. During inhalation, the vacuum under the vest (in the case where the vacuum under the vest pulls the torso out, rather than adhesive connections) must increase by an amount fairly close to the pressure that would be used for positive pressure ventilation during the inhalation cycle. During exhalation, a positive pressure will normally be applied through direct mechanical contact of the vest with the skin.

In the conformal method of operation of the CVV, there may be a vacuum under the vest during both the exhalation cycle and the inhalation cycle through a layer of fabric with an interstitial vacuum attaching the vest to the skin. In this case, care must be taken that the constant vacuum does not cause bruising.

In the flexible cuirass mode of action, the CVV acts as a sort of flexible cuirass ventilator, by trapping a bucket of air between the vest and the skin surrounding the thoracic cavity. In this case, breathing is mediated by changing the gas pressure under the cuirass. In this mode the gas pressure under the flexible cuirass may go from negative to positive in each breathing cycle. But unlike a normal cuirass ventilator, both the pressure and the vacuum are created by deformation of the vest itself.

This is not quite as energy efficient as the mode described above in which a steady direct mechanical contact is always maintained between the vest and the torso. However, the volume change in the gas space between the vest and the skin can be quite small even in the flexible cuirass mode of operation.

The conformal mode of operation is more energy efficient compared to the flexible cuirass mode of operation, but the expanding flexible cuirass version of this CVV may be more comfortable to wear. The conformal mode of action of the CVV allows the CVV to be worn under clothing more discreetly than the flexible cuirass mode of operation.

In the version of the CVV for use under clothing, the lengthening mechanical elements are desirably incorporated into a form-fitting vest, at least a portion of which moves with the body during the inflation/deflation cycle.

For the CVV to work, at least a portion of the torso must move with the vest as it expands. A key realization in this regard is that though the vest must be stretchable around the part of the chest that expands, it is not desirable for the back portion of the vest to be made of a stretchable fabric.

Thus the CVV desirably contains at least two different types of fabric, one which is not very stretchable and the other which is stretchable to the extent which is required to enable the lengthening mechanical elements to move as they are designed to do, while also maintaining contact through the low gas pressure zone under the vest to the thorax.

If an adhesive is used to maintain contact between the CVV and the torso, then only a portion of the total area of contact between the torso and the CVV needs to be adhered. If on the other hand, a modest vacuum is created during the inhalation cycle between the CVV and a portion of the torso, said vacuum may only be applied to the front part of the torso, similar to the way that a cuirass works, or it may work better for the vacuum to go all the way around the torso. This second option avoids the need for gas tight seals along the sides of the torso which has been a problem for the Hayek Medical BCV device.

In the scenario in which a vacuum is applied around the entire torso area, the entire area which lies between the upper edge and the lower edge of the CVV, including the backside of the vest, would be within the vacuum.

### BRIEF DESCRIPTION OF THE DRAWINGS

FIG. 1 shows a male torso 10 surrounded by the CVV. The front portion of the CVV 11 contains 21 individual lengthening mechanical elements, linked together by a manifold 16. The back portion of the CVV 12 is comprised of fabric that is not stretchable. A control unit 13 regulates the flow of energy from a power source 14 through a power connection 15 to a manifold 16 on the left side of the front portion of the CVV; feature 16 is a hinge joint which also comprises a manifold to distribute the driving energy to the lengthening mechanical elements which comprise the expandable front portion of the vest. On the right side of the actuated portion of the vest is a closure 17. Feature 18 is a strap over the shoulders

FIG. 2 shows a female torso 20 surrounded by the CVV. The front portion of the CVV 21 contains 21 individual lengthening mechanical elements, linked together by a manifold 26. The back portion of the CVV 22 is comprised of fabric that is not stretchable. A control unit 23 regulates the flow of energy from a power source 24 through a power connection 25 to a manifold 26 on the left side of the front portion of the CVV; 26 is a hinge joint which also comprises a manifold to distribute the driving energy to the lengthening mechanical elements which comprise the expandable front portion of the vest. On the right side of the actuated portion of the vest is a closure 27.

FIG. 3 shows a complete circular hoop of toroidal anisotropic tubing containing a variable volume of hydraulic fluid at varying pressure. Three radii are shown in FIG. 3, 34 is the radius (r₄) of the axis of symmetry of the toroid. Radius 35 (r₅) traces the innermost portion of the toroid. Radius 36 (r₆) is the outermost radius of the toroid. A_A shows the location of a cut through the toroid which is shown at a 90° angle to the illustration in FIG. 3, shown in FIG. 6.

FIG. 4 shows an oblique view of one half of the toroidal hoop of FIG. 3. An end on view of the ½ toroidal loop is shown in FIG. 3.

FIG. 5 shows one anisotropic tube 53 which forms a part of the front actuated portion of a CVV as in 11 or 21, together with similar anisotropic tubes above and below. The spacing between the tubes is h₁ 51.

FIG. 6 shows a cross-section of the toroidal hoop of FIG. 3. The radius (r₁) at the interface between the hydraulic fluid and the isotropic inner portion of the elastomeric tube wall is 61. The radius (r₂) at which an inner isotropic elastomer interfaces with an anisotropic outer portion of the tube wall is 62. The outer radius (r₃) of the tube is at 63. The inner portion of the tube inside radius r₁ 61 contains a fluid 64 at pressure P₁ 67. The innermost portion of the tube wall lying between 61 and 62 is an isotropic elastomer 65. The outermost portion of the tube wall lying between 62 and 63 is an anisotropic elastomeric layer 66.

FIG. 7 shows two states of an anisotropic inflatable tube; 70 shows the uninflated state and 80 shows the inflated state. 71 is the helix angle for the uninflated state and 81 is the helix angle for the inflated state. The height of the illustrated helically wound fibers in the uninflated state is 72, and the height of the helically wound stack of fibers in the inflated state is 82. The axis of symmetry in the uninflated state is 73 and the axis of symmetry in the inflated state is 83. FIG. 8 shows several different pressure versus strain behaviors which are discussed in Example 1 and Example 2, and in Table 1 and Table 2. The location indicated by 91 is the basis for Table 1, column 4. The location indicated by 95 is the basis for Table 1, column 5. The straight line 92 between the 0-strain axis and 91 shows the approximate relationship of hydraulic inflation pressure P₁ 67 to the axial extension of a simplified anisotropic tube, given the values of elastomer modulus and P_{diff} of Table 1 column 4. The straight line 96 between the zero strain axes and 95 shows the approximate relationship of hydraulic inflation pressure P₁ to the axial extension of a simplified anisotropic tube given the values of axial tube wall modulus and P_{diff} of Table one column five. The lines showing P₁ versus axial strain 93, 94, 97, and 98 show the deformations modeled in Table 1 and Table 2 in which P_{diff} goes from zero strain to a high value as the strain in the tube wall is varied. 98 corresponds to the lower estimate of Table 1, and 94 corresponds to the upper estimate of Table 1. 93 corresponds to column four of Table 2, and 97 corresponds to column 5 of Table 2.

FIG. 9 shows a stress strain curve 101 for an elastomer tube as shown in FIG. 6 and FIG. 7. Young's Modulus is the slope defined by 102. Stress at 10% strain 104 defines the 10% secant modulus 103 (1.91 MPa in Example 2).

FIG. 10 illustrates the force equilibrium between the force F₃ 113 due to elastic stress in the tube wall (as per the stress strain data of FIG. 9 and the dimensions shown in Table 2), the force F₂ 112 arising from a constant value of P_{diff} (3750 Pa, as in Table 2 and Table 3), and the force F₁ 111 arising from hydraulic pressure 67 inside the inflatable elastomer tube versus axial strain of the toroid, as in FIG. 7 and FIG. 9.

### DESCRIPTION OF EMBODIMENTS

The CVV is a combination of these functional components:
1. A flexible part of the vest covers at least the front part of the torso.
2. Optionally laterally stiff fabric forms the back part of the vest which contacts the back part of the torso.
3. An inner part of the vest is designed for interfacing with the skin. This layer will be different if the adhesion between the vest and the torso is via adhesives versus a vacuum.
4. For the specific case where a mild vacuum is used to maintain connection between the torso and the vest during inhalation, it is desirable that a layer of the vest have controlled low permeability so that fresh air is still getting to the skin under the vest even while a vacuum pump or other means as described below maintains the vacuum level during inhalation of air into the lungs.
5. Where adhesives are used to create the mechanical connection between the skin around the thoracic cavity and the CVV (which expands during the inhalation cycle), it is feasible to adhere bandages that have Velcro or other means of attachment on their outer surface and which couple up with mating features on the inside of the vest. In this implementation of the vest it is possible for the vest to be a sort of framework around the body rather than a fabric-based structure. This method of attachment might be better for use in a hospital or a critical care situation because it can be put around the thoracic cavity with minimal interference with medical access to the body, whether for surgery or other procedures.
6. Optionally, the expandable part of the vest can also include mechanical structures which contract to aid expiration of air after the inhalation is complete. Said mechanical structures may either contract slowly, for normal expiration, or they may contract rapidly for other purposes. Said rapidly contracting elements would be particularly useful for the cough assist mode of operation. Muscle wires are useful for causing such a rapid contraction.
7. A means of attachment between the lengthening mechanical elements and the front part of the vest. One method of attachment is to make the vest out of a stretchable fabric which can follow the motion of the lengthening mechanical elements as they go through their cycle. It is also useful to have a sleeve that holds the lengthening elements as they move. Such a sleeve is designed so that the lengthening mechanical element can readily slide along the inner surface of the sleeve.
8. There needs to be a driver to power the lengthening mechanical elements which get longer and then shorter to cause the breathing effect. This driver will be at least in part electrical. The electrical part may either drive a variable gas pressure, a variable liquid pressure, or it may drive an electromechanical mechanism directly which resides in the wall of the vest.

One version of the CVV involves a fabric sleeve which is connected to the flexible outer portion of the vest. This sleeve can be made of the same flexible fabric used for the front part of the vest, or it can desirably be a different material selected for low sliding friction against the expanding and contracting mechanical elements.

If the said sleeve is stretchable it may move with the tube as it lengthens. Alternatively, said sleeve may comprise belt loops which are not stretchable in themselves, but which are attached at intermediate points along the stretchable portion of the vest.

In the case that the lengthening mechanical elements within said sleeves are held close to the skin either by a vacuum or an adhesive, it is desirable for the inner surface of said sleeves to slip relative to the expanding mechanical element. This allows for a lateral displacement between the lengthening element and the skin which is desirable to avoid shear stress in the subcutaneous layers below the skin.

This method of attachment involving slidable sleeves or belt loops is preferred for the conformal version the CVV in which there is a very small separation distance between the lengthening mechanical elements and the skin below, because it allows the motion of the skin to be decoupled from the motion of the expandable structural elements. This will be less likely to cause lateral motion of the vest relative to the skin during the inflation/deflation cycle. On the other hand, the CVV can operate through an intermediate gas layer, comprising an air bubble between the low permeability portion of the vest and the skin. This method of operation comprises a flexible cuirass ventilator. In this case it is not important for the lengthening mechanical elements to slide during their motion. Said means of attachment creates a gas pressure mediated connection with the skin of the torso and thereby, a gas pressure mediated connection to the thoracic cavity.

The lengthening mechanical elements can slide through slippery rings or belt loops which are mechanically attached to the vest. The mechanical means of coupling can also be some form of sliding bearings, including bushings or ball bearings.

In a preferred embodiment of the invention the lengthening mechanical elements which actuate the expansion and contraction of the vest comprise elastomeric tubes which contain two different layers of elastomer and a manifold through which a hydraulic fluid is added and removed during each inhalation/exhalation cycle.

The inner elastomeric layer is desirably isotropic and has a relatively low modulus and hysteresis. This inner elastomeric layer desirably has lower density then the hydraulic fluid used, to minimize the weight of the vest.

During pressure cycling of the vest, this inner isotropic elastomer layer is in effect part of the pressurized fluid within the outer anisotropic layer, which will in most cases include strong high-modulus fibers in addition to the elastomer.

The outer elastomeric layer needs to have good oxidation resistance if the tubes are to last for many years as they should. That may rule out natural rubber which otherwise would have excellent properties for this layer. One desirable solution is to have most of the tube elastomer comprise natural rubber but then to have an oxidation resistant elastomer with low oxygen permeability on the outside of the tube to protect the natural rubber from oxidation and other issues such as ozone.

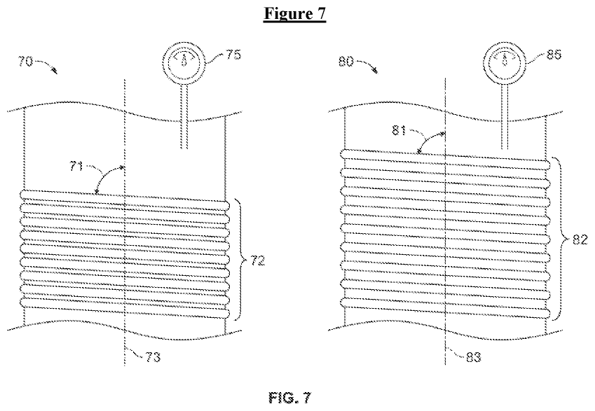

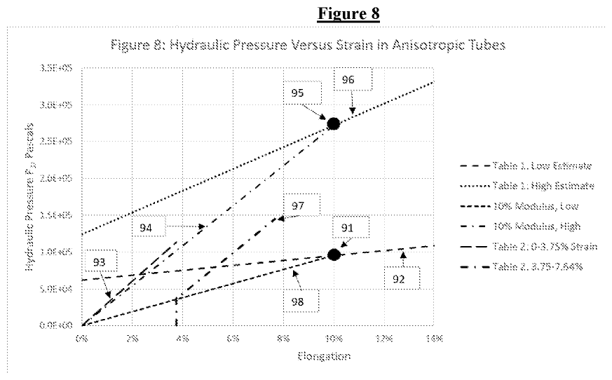

Said outer anisotropic elastomer layer needs to have a higher modulus in the circumferential direction of the tube compared to the longitudinal direction of the tube. That can be accomplished using helical fiber wound around the tube as in Example 2 and FIG. 7, or it can involve short fiber composites. In either case it is desirable for there to be good adhesion between the elastomer and the fiber.

### Acronyms used in the Description

| | |
|---|---|
| cm | centimeters |
| COPD | Chronic Obstructive Pulmonary Disease |
| CVV | Conformal Vest Ventilator |
| J | joules |
| m | meters |
| mm | millimeters |
| MPa | megapascals |
| N | Newtons |
| NPV | negative pressure ventilation |
| Pa | Pascals |
| PEEP | Positive end-expiratory pressure |
| PPV | positive pressure ventilation |
| W | watt |

### Prior Art

IRON LUNG VENTILATOR: The Iron Lung ventilator is a negative-pressure ventilator that initiates inhalation by creating a partial vacuum around the thoracic cavity. The entire body is placed inside a vacuum chamber. The head remains outside of the chamber and a seal is made around the neck. Iron lungs can alternate between negative and positive pressure to actuate both inhalation and exhalation.

CUIRASS VENTILATORS: A more recent approach to negative-pressure ventilation is the cuirass ventilator, e.g., Hayek Medical's Biphasic Cuirass Ventilator (BCV). With the BCV, positive and negative pressures are applied only to the chest area.

German patent DE212014000239U1 describes an inflatable cuirass variant of the cuirass ventilator in which inflation pressure is used to expand a flexible cuirass; breathing is actuated by a pressure change under this flexible inflatable cuirass, rather than through inflation/deflation of the flexible cuirass per se.

U.S. Pat. No. 7,435,233B2 describes a variant of the cuirass ventilator in which two rigid shells surround the torso. And in permeable polymer layer it surrounds these two shells, and a mechanical mechanism causes the shells to separate to initiate inhalation. This causes an increase a volume inside the two shells around the body. This device would be extremely uncomfortable to use while sleeping. It expands and contracts to cause a breathing action via changing gas pressure around the torso. This device is not form-fitting nor can it be used under clothing. In this case the shells surround the entire torso, and the two halves are mechanically pushed apart to create the breathing action.

A recent refinement of the cuirass ventilator concept US patent application 20190105225A1 (AIR-AD), is being developed by RightAir (http://rightair.io). This modification uses a smaller cuirass for each patient that is customized to the patient's body shape. Additionally, the weight of the device is supported on the hips rather than the shoulders. The smaller volume of air under the cuirass improves the energy efficiency of the device compared to prior art cuirass ventilator devices, and therefore improves portability compared to the Hayek Medical BCV.

With both the iron6 lung and cuirass ventilators, a much larger volume of air than the lung's capacity must have its pressure changed during the breathing cycle.

SUCTION-DEVICE VENTILATORS: Prior-art exists for ventilators that use various types of suction devices attached to the chest to create inhalation. The Lucas 3 Chest Compressor by Stryker employs a suction device that, in addition to breathing support, can perform cardiopulmonary resuscitation by inducing heart compressions leading to pumping. The mechanism does not involve creation of a vacuum around the thoracic cavity.

The PXT ventilator from Delta Dynamics LLC (U.S. Pat. No. 10,478,375) expands the thoracic cavity via suction cups that are applied to the chest and attached to motors and gears on a rigid framework around the body. This is like the mechanism of Lucas Medical's Chest Compression System; this is not an ambulatory system.

INFLATABLE STRUCTURES: There are many examples of the use of inflatable structures to cause a mechanical motion such as WO1998049976A1 and US patent application 2005/0234292. Recently there has been a flurry of work on soft robots. The inventors are not aware of any prior art device that uses inflatable tubes or elongating structural elements to create a vacuum around the thorax.

The Hayek Medical BCV and the AIR-AD from RightAir LLC are the only somewhat portable negative pressure ventilators of which the inventors are aware. There are numerous positive pressure ventilators which are portable including Philips Respironics' Trilogy 100, Hill-Rom's Life2000, and Ventec Life Systems' VOCSN.

Among the prior art ventilators, the Trilogy 100 from Philips Respironics has the best energy efficiency, achieving ventilation of a typical patient with about 15 watts of power.

### EXAMPLES OF THE INVENTION

### Example 1

Example 1 is a simplified computational example of the core technology that makes the vest ventilator work, in the preferred version in which the lengthening mechanical elements are based on anisotropic inflatable elastomeric tubes.

In this example we model a single anisotropic inflatable tube formed into a toroidal shape, and then calculate pressure, shape changes, and energy needed to drive the shape changes that actuate the CVV. Although the model is developed by considering full circular toroids, only about 40% of the total circumference of such a toroid is used in the front, actuated portion of the CVV.

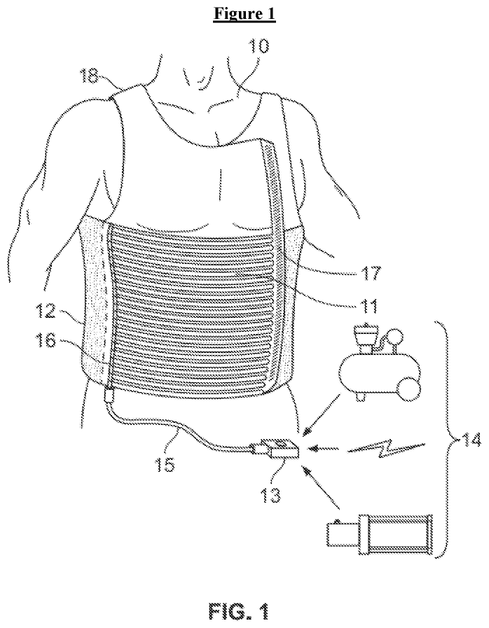

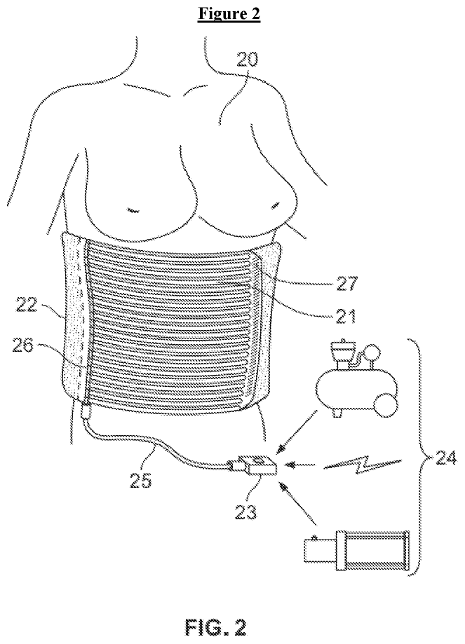

These toroidal segments are stacked up and linked to a hydraulic fluid source via a shared manifold; for the purpose of this example, 21 of these toroidal segments are used to form the front part of the CVV, as in features 11 or 21 of FIGS. 1 and 2. This stack of toroidal segments are comprised of anisotropic inflatable tubes which form the actuated front portion of the CVV which moves with the body during the breathing cycle.

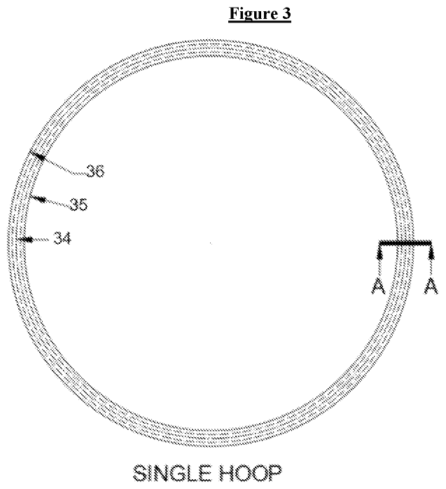

To explain how the invention works consider FIGS. 3 to 10.

FIG. 3 illustrates a single toroid of anisotropic inflatable tube of a preferred embodiment of the invention. It is a circularly symmetrical hollow tube bent around into a toroid. The toroid is formed out of hollow anisotropic tubing with an incompressible fluid inside the tubing. A_A illustrates a cross section cut in the tubing perpendicular to the local circumferential direction of the toroid, which is shown in an end on view in FIG. 6.

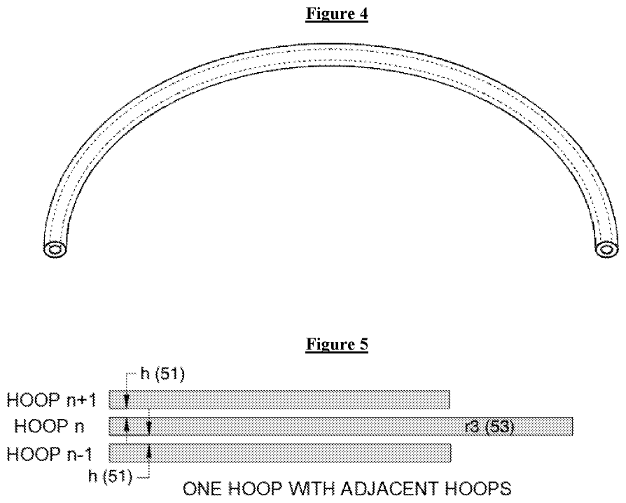

FIG. 4 shows a toroidal segment of the loop of tubing shown in FIG. 3; one half of the toroid of FIG. 3, which has been bisected by a plane that is perpendicular to the circumference of the toroid. FIG. 4 is designed to aid in visualizing the type of vest illustrated by FIG. 1 and FIG. 2 in which the tubing surrounds only a part of the torso, typically between 30% to 50% of the circumference of the torso surrounding the thoracic cavity. We have adopted 40% of the total patient circumference for the detailed modeling represented by Table 1 to Table 3, and FIG. 8 through FIG. 10.

FIG. 4 also helps in visualizing the force equilibrium which can be described in terms of half of a full toroid in an equilibrium of forces versus the other half. FIG. 10 shows this force equilibrium for real anisotropic tubes as per Example 2.

The inflatable tube forming the half toroid of FIG. 4 comprises an example of the lengthening mechanical elements for the version of the conformal vest ventilator in which anisotropic inflatable tubes go around the belly and/or chest of the patient needing ventilation, as shown in FIG. 1 and FIG. 2. The back portion of the ventilator need not be actuated by anisotropic inflatable tubes if it fits snugly enough around the body so that when the tubes inflate the connection between the inflatable elements and the torso can be maintained.

It is convenient to consider the full toroid as shown in FIG. 3, split into two halves as in FIG. 4 in order to calculate the force equilibrium involved in determining the shape of the inflatable toroid given different pressures in and around the toroid for the purpose of explaining the movement of the toroid as it is inflated. This is the basis for the calculations below and for the graphical depiction of the force equilibrium shown in FIG. 10.

When the lengthening anisotropic tubes cover only a portion of the circumference around the patient, then the lengthening of the anisotropic tubes during the inhalation cycle must be greater than would be the case if the tubes went all the way around the torso. FIG. 1 and FIG. 2 illustrate the case where the inflatable tubes wrap around 40% of the torso. As the lengthening anisotropic tubing is reduced from 100% of the circumference around the body to a lower percent, the lengthening of the mechanical elements must increase proportionately. For example, if the lengthening mechanical elements follow the circumference of the torso for only 40% of the circumference around the torso, the anisotropic inflatable tubes must move two and a half times more in axial strain in order to actuate the same volume change inside the CVV compared to anisotropic tubes which extend all the way around the body as in FIG. 3.

Table 1 models two equilibrium states of the tube at 10% strain corresponding to 91 (column four), or 95 (column five). Results are presented for both a relatively low modulus elastomer (10% secant modulus equals 1 MPa) and a relatively high modulus elastomer (10% secant modulus equals 5 MPa).

Consider the case where the total circumference around the torso is 100 cm as in Table 1. If the circumference change around the torso during the breathing cycle is 4%, which implies a circumference increaseof 4 cm, this implies a 10% elongation of the 40 cm anisotropic tubes forming the CVV.

The strain conditions of Table 1 represent an upper bound for the lengthening mechanical elements of the CVV. A typical patient that has a 100 cm circumference and a breathing volume of 2 liters of air per breath would have a circumference changeof 1.5 cm. Example 2 uses this more realistic estimate for the lengthening of the mechanical elements.

TABLE 1
Simplified Treatment of Inflatable Hoop Made of Anisotropic Tubing

| | 10% Modulus, | Elastomer Modulus, MPa: | 1.00 | 5.00 |
|---|---|---|---|---|
| | Mpa: | | | |
| | Drawing | | | |
| Symbol | Ref. # | Definition | | |
| r₁ | 61 | inside tube radius (cm) | 0.423 | 0.423 |
| r₂ | 62 | radius, boundary isotropic/anisotropic layers (cm) | 0.564 | 0.564 |
| r₃ | 53, 63 | outside tube radius (cm) | 0.5682 | 0.5682 |
| r₄ | 34 | characteristic undeformed hoop radius (cm) | 15.92 | 15.92 |
| h₁ | 51 | separation between hoops in the vest (cm) | 0.29 | 0.26 |
| P₁ | 67 | hydraulic fluid pressure (MPa) | 0.12 | 0.41 |
| P_{diff} | — | differential pressure, inside to outside hoop (Pa) | 2.50E+03 | 5.00E+03 |
| F₁ | — | hydraulic force pushing hoop apart (N) | 24.5 | 81.5 |
| F₂ | — | force due to vacuum pulling hoop together | −13.66 | −27.31 |
| F₃ | — | elastic retractile force in both tube walls (N) | −10.84 | −54.19 |
| A₁ | — | cross-sectional area of the tube inside r₂ (cm²) | 1.00 | 1.00 |
| A₂ | — | cross-sectional area of tube wall (cm²) | 0.542 | 0.542 |
| A₃ | — | total area perpendicular to hoop + h (cm²) | 54.62 | 54.62 |
| sₘₐₓ | — | modeled strain of inflatable tubes | 10% | 10% |
| | | patient circumference % inflated by actuated tubes | 40% | 40% |
| | | cm³ increase in tube during breathing cycle | 4.00 | 4.00 |
| | | energy (J) per cycle based on PV change in tube | 0.24 | 0.82 |
| | | power (W) based on 12 breathing cycles/minute | 0.05 | 0.16 |
| | | power (W) based on 20 torodial hoops per CVV | 0.98 | 3.26 |
| | | power (W) based on 50% recycling of elastic energy | 1.22 | 4.08 |

For Table 1, we adjusted r₄=15.92 cm so that circumference of the undeformed toroid is 100 cm. The pressurized tube radius r₂=6 mm, modulus values for the tube wall M₁=M₂=(1.0 or 5.0) MPa. We modelled two differential pressures P_{diff} inside the toroid versus outside the toroid: 2500 Pa and 5000 Pa.

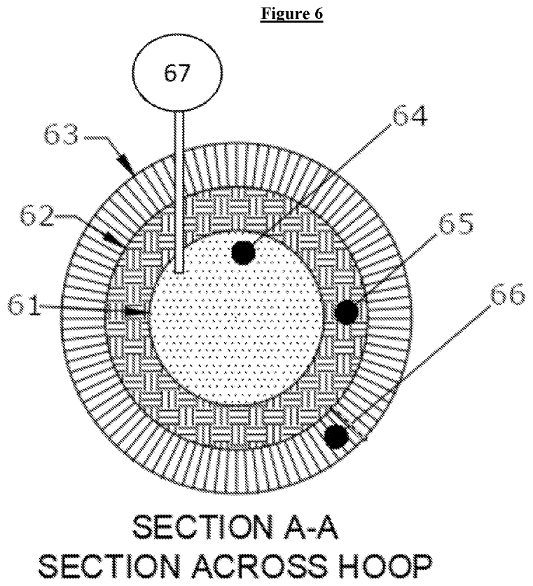

FIG. 5 shows how several inflatable toroids as in FIG. 3 and FIG. 4 can be stacked up to create the lengthening mechanical elements part of the CVV. For Table 1, we have assumed 21 inflatable tubes have been stacked up to form the actuated section of the CVV as in 11 or 21.

FIG. 6 shows one form of an anisotropic elastomeric tube in more detail. The tube wall has 2 elastomeric layers, the outermost of which has anisotropic mechanical properties.

Neither FIG. 3 or FIG. 4 show the means for introducing fluid and removing fluid from the tubing which is bent around into a circular toroid. There are numerous ways to accomplish that.

Although in this example the inflating fluid is a nearly incompressible hydraulic liquid, it is also possible for that fluid to be a gas. Using an incompressible fluid instead of a gas reduces heat generation per cycle and energy that must be consumed to actuate each breathing cycle.

FIG. 3 shows a single circular toroid formed from an anisotropic inflatable tube. FIG. 6 shows a cross section of the tube which forms the toroid of FIG. 3. Six radii are defined in FIGS. 3 and 6.
r₁ 61 is the radius at which the interface occurs between the inflating hydraulic fluid and the inner elastomer wall of the tube.
r₂ 62 is the radius where the inner isotropic elastomeric portion of the tube wall interfaces with the outer portion of the tube wall with anisotropic mechanical properties.
r₃ 63 is the outer radius of the tube.
r₄ 34 is the radius of the toroid, defined by the circular path of the center of symmetry of the tube which is bent around into a circular toroid.
r₅ 35 is the innermost radius for any part of the toroid.
r₆ 36 is the outermost radius for any part of the toroid.

(Tables 1-3 also link the mathematical symbols used in this section with the numeral references in the drawings.)

This example elucidates the relationship between inflation pressure of an anisotropic tube which forms the toroid, the elastic stress in the tube wall, the shape of the toroid, and the hoop stress P_{diff} due to the pressure difference inside the toroid versus outside the toroid. This simplified treatment does not account for resistance to lengthening of the tube from friction between the tube and the sleeve in which it resides.

The effective pressure P_{diff} between inside the toroid and outside of the toroid has one component which is caused by the gas pressure difference, and a second component due to mechanical contact between the vest and the torso. Outside the toroid, this is simply the atmospheric pressure, and inside the toroid, it is possible for the gas pressure to be lower than P_{diff} (in order to maintain good mechanical contact between the CVV and the torso).

The individual toroidal segments of the vest ventilator should not be attached to each other in the vest so that each inflatable tube can move somewhat independently from its neighbors. There needs to be clearance between next neighbor inflatable toroidal tubes to allow for flexibility of motion for each individual inflatable tube within the vest. Because of this there is a gap between next neighbor anisotropic inflatable tubes, as shown in FIG. 5. That gap h₁ 51 has the dimension 0.26 cm, as shown in Table 1, which is about 20% of the diameter of the tube prior to inflation (h₁ was adjusted so that the total height of the 21 anisotropic tubes forming the front part of the CVV is exactly 30 cm).

The middle toroidal tube shown in FIG. 5 53 is one layer of a repeated structure in which each toroid has 0.5h₁ 51 clearance above and 0.5h₁ 51 clearance below. Such repeated structures can be stacked up to form a cylinder which is the actuated portion of the vest comprising lengthening mechanical elements of a CVV.

This example uses simplifying assumptions to enable an analytical model which is easier to understand than the full-out finite element analysis of a CVV. The simplifications used for this example and Table 1 are listed below:
The elastomer parts of the inflatable tube are in a zero-stress state when the tube is not deformed.
The anisotropic elastomer layer on the outside of the tube is taken to be uniformly anisotropic in that the axial direction of the toroidal segment of anisotropic tube (the circumferential direction of the toroid) has a higher modulus M₃ compared to the modulus in the circumferential direction around the and I said tropic inflated tube forming the toroid M₂ or the modulus in the thickness direction M₄ of the tube. The radius r₂ 62 is taken to be a constant. This mathematical simplification is a way of expressing that the circumferential modulus M₃ of the outer layer of the tube in this direction is much greater than the moduli in the two directions which are orthogonal to the circumferential direction around the tube. Modulus M₃ is much greater than the modulus anywhere else in the tube in any other direction. Modulus values in the tube wall as described above can be modeled by taking an infinite circumferential modulus of the tube wall at r₂, which is what this simplifying assumption implies.
The density of the elastomer and the fiber reinforced elastomer layers are assumed to be constant.
The elastomer modulus of the innermost part of the tube M₁ is isotropic in all three orthogonal directions, and for this simplified treatment M₁ is equal to the axial modulus M₂ of the anisotropic outer portion of the tube (in the axial direction of the toroid).
Since the tube is bent around into a toroid, it is not quite circular in cross-section, however it is assumed to be circular for this simplified calculation.
The radius of the toroid for purposes of calculating hoop stress is r₄ 34 and is at the middle of the tube which forms the toroidal segment which is deployed in the front part of the CVV.
The elastomer tubes are assumed to be perfectly elastic. (This can later be modified to account for hysteresis.)

The simplifying assumptions above reduce the complexity of explaining the mechanical behavior of the CVV device based on anisotropic inflatable tubes. The resultant analytical model based on these simplifying assumptions makes it simple to show the relationship between the inflation pressure in the tube and the vacuum level that can be created inside the toroid. It also makes it simple to calculate the energy expended per inhalation cycle.

Actual devices can be modeled with a finite element modeling method, in which case it is not necessary to make the simplifying assumptions of this example.

Table 1 shows typical results from such a calculation for realistic anisotropic elastomer tubes. The exact state modeled corresponds to 91 or 95 of FIG. 8. This is based on the calculation of stress versus strain as per the 10% secant modulus, as illustrated by 103 of FIG. 10. The first two columns in Table 1 define the relationship between dimensions discussed in Example 1 with the various illustrations from FIGS. 3 to 10.

It is desirable to actuate the CVV by injecting hydraulic fluid at a controlled rate. This also facilitates detailed control of the rate of inhalation and exhalation.

For the purpose of calculating the energy used per cycle, one can get a reasonable estimate by assuming that the inflation pressure goes linearly from a low value to a high value and back. (The actual pressure inside the tubes will always be less than or equal to the maximum pressure in the tube, so although the actual pressure versus time curve will not be linear, this is at least a reasonable estimate for the hydraulic work done during the inhalation cycle.) This corresponds to the pressure versus axial strain lines 94 and 98 of FIG. 8.

Given this simplification, the energy required per breathing cycle will be approximately half of the PV energy indicated by multiplying maximum hydraulic pressure Pi times the hydraulic fluid volume change inside anisotropic tubes forming the front part of the vest during the breathing cycle, as indicated by the area under the pressure versus axial strain lines of FIG. 8.

The pressure versus axial strain line indicated by 94 represents a high-side estimate for the hydraulic inflation pressure versus axial strain, and 98 shows a low side estimate for this property.

Table 1 assumes an axial toroidal circumference around the thoracic cavity of 100 cm, and uses a high side estimate of the circumferential change during a breathing cycle of 4 cm, which applies to a toroid segment that starts out at 40 cm. (These dimensions were selected so that the axial strain in the toroidal segment would be 10%, and the circumferential strain around the thoracic cavity would be 4%, which is higher than the actual strain would be for most patients.)

The pressurized radius of the anisotropic tubes r₂ was adjusted so that the cross-sectional area perpendicular to the tube axis is 1.00 cm².

By making these adjustments it is easier to visualize the relationship between strain and volume change inside the anisotropic inflatable tubes because a 1% circumferential strain will occur for each cubic centimeter of hydraulic fluid injected into the toroid.

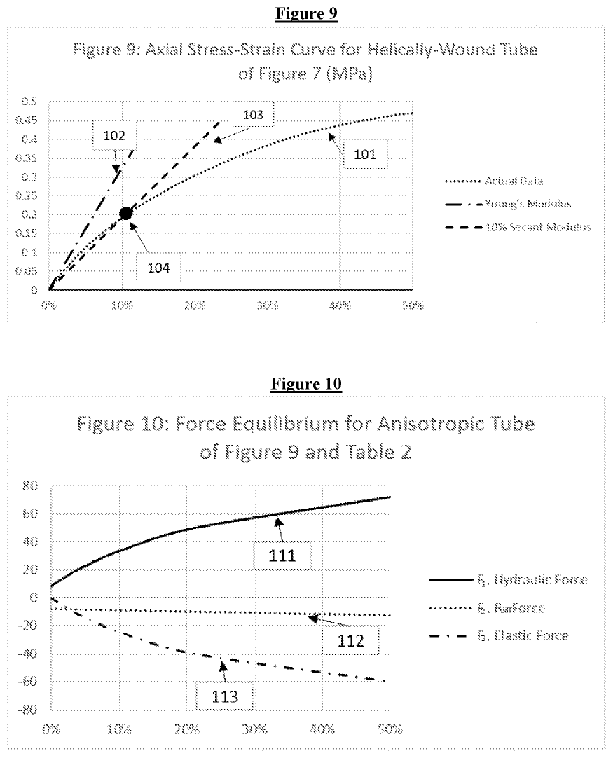

Column 4 of Table 1 describes a relatively low modulus elastomer tube (1.0 MPa, defined as the 10% secant modulus similar to feature 92 of FIG. 9) with a relatively low maximum vacuum level P_{diff} (−2500 Pa) inside the toroid during the breathing cycle. Column 5 of Table 1 gives results for a relatively high modulus elastomer (5.0 MPa secant modulus at 10% elongation) in which the vacuum that is attained at the end of the inhalation cycle P_{diff} is −5000 Pa. These two states represent a range of anisotropic tube properties but are not indicative of the maximum range of tube modulus or P_{diff} that could be used in the invention.

The deformed dimensional state of the inflatable anisotropic tubes shown in columns 4 and 5 of Table 1 are the same. The outer diameter of the tubing forming the toroid is 1.13 cm before and after deformation, and the modeled state corresponds to 10% strain in the axial direction of the toroidal segment (40 cm long before inflation, 44 cm in the deformed state of Table 1).

The actual shape adopted by the inflated toroid is a function of shape of the torso lying below the CVV and the volume of fluid inside the toroidal segment tube. If the vacuum level under the CVV is high enough, the anisotropic inflatable tubes will follow the shape of the torso below. If the vacuum level between the CVV and the torso varies between nearly zero to its maximum value, then there may be gaps between the inner surface of the CVV and the torso of the patient during the breathing cycle. In the case that there is a constant vacuum within the CVV adequate to maintain contact with the torso below even at the end of the exhalation cycle, this constant vacuum does not enter into the energy required for the breathing cycle.

The volume of liquid inside the tubes which form the toroidal segments within the CVV controls the hydraulic pressure inside the tubes, which also depends on the difference between the pressure inside the toroid versus the pressure outside the toroid P_{diff} (this is the pressure differential which drives ventilation), and the elastic stress of the various layers of the inflatable anisotropic tube.

The wall of the tube which forms the toroid can have different modulus values in two separate layers. Between r₁ 61 to r₂ 62, the tube wall 65 is isotropic prior to deformation. Between r₂ 62 to r₃ 63 is an anisotropic (typically fiber-reinforced) elastomer layer 66 which can be modeled as if it is a microscopically uniform material with anisotropic modulus values in the axial direction of the tube and of the circumferential direction of the toroid M₂ vs. the modulus M₃ in the circumferential direction around the anisotropic portion of the tube wall 66.

In an optimized anisotropic inflatable tube for the CVV, the inner isotropic elastomeric layer 65 between r₁ 61 to r₂ 62 should have low stiffness and typically a durometer between 20 to 60 Shore A, and preferably lower density than the hydraulic fluid. It should also have low hysteresis over the course of the normal deformation of the tube to minimize wasted energy and heat production. It is important that this layer of elastomer not have much self-tack, to prevent it from collapsing and not coming apart readily. Both elastomer layers 65 and 66 need excellent resistance to swelling by the hydraulic fluid.

Examples of appropriate elastomers for this inner layer 65 include natural rubber, EPDM, synthetic cis-polyisoprene elastomer, and thermoplastic elastomers with relatively low durometer values, below 60 Shore A durometer. Silicone elastomer may also be used.

The elastomer used in 66 between r₂ 62 and r₃ 63 should have low stress relaxation (important because the elastomer retraction helps with the exhalation of air by the patient), better oxidation resistance than natural rubber, and excellent fatigue properties as well as fiber adhesion properties. Some of the elastomers that are particularly suitable here include elastomer blends typically used in tire sidewalls, NBR rubber, and HNBR rubber. A desirable composition to use for this compound formulation comprises nano fibers of polyaramid pulp with a mixture of NBR and HNBR.

The axial modulus M₂ in the outer anisotropic layer 66 of the anisotropic tube need not be the same as the modulus M₁ in the isotropic elastomer layer 65 that lies between r₁ 61 to r₂ 62, 65, although we have adopted that simplification for this example.

It may be desirable that M₁ and M₂ are significantly different. The elastomer layer 65 may for example be optimized to minimize viscoelastic hysteresis per cycle, while the fiber-reinforced elastomer layer 66 may be optimized to minimize creep and stress relaxation, buckling tendency, and also to optimize the fatigue resistance at the fiber/elastomer interface.

Alternatively, the entire anisotropic tube wall can be formed from fiber reinforced elastomers as in the outer layer of the tube 66 shown in FIG. 6, without the inner isotropic layer of said tube 65.

The modulus in the circumferential direction M₃ of the anisotropic portion of the tube wall 66 is significantly higher than the modulus M₂ of the anisotropic portion of the tube wall in the axial direction of the tube (which is perpendicular to the page in FIG. 6, and is also the axial direction of the toroidal segment).

The three vectors defining M₂, M₃, and M₄ (the thickness direction in the tube wall 66 are orthogonal at all points along the inflatable toroid. It is possible to generalize the behavior of these anisotropic inflatable toroids regardless of what material and methodology is used to create the anisotropic properties in the tube which forms the toroid.

Said anisotropic properties in the tube wall can be created via fibers embedded into an elastomer matrix, or through differential orientation in the elastomer matrix itself. In the case that fiber reinforcement of the elastomer is used to create the anisotropy, the fibers used within the elastomer matrix may be either long fibers as shown in FIG. 7 or short fibers (including nanofibers such as polyaramid pulp or carbon nanotubes). In both cases, the fiber orientation should be in the circumferential direction of the tube as nearly as possible.

Said elastomer matrix may comprise a cross-linked elastomer or a thermoplastic elastomer such as triblock polymers (such as Kraton™ G), dynamic vulcanizate thermoplastic elastomers such as Santoprene™, thermoplastic polyurethanes, or multiblock polymers like Hytrel™

One of the simplifying assumptions deployed here is that the tube cross section remains circular even though the tube is bent around into a larger toroid. This is incorrect, but the errors introduced by this assumption are small if the ratio of the toroid radius r₄ 34 to the tube radius r₃ 63 is greater than 10.

We have considered values of axial versus circumferential modulus of the tube that are reasonable for a fiber reinforced elastomer. Such realistic numbers are used in our finite element modeling of the vest, but for this example the assumption that r₂ is a constant is equivalent to assuming an infinite modulus in the circumferential direction of the tube at radius r₂ 62.

When the tube is inflated with a volume of incompressible liquid, all dimensions except for r₂ 62 will change given the simplifying assumptions above. The tube will get longer to make room for the added fluid, which means the circumference of the toroid increases in direct proportion to the volume of liquid introduced into the inflatable toroid, and the wall thickness of the tube must decrease.

The relative increase in circumference around the patient's thoracic cavity is equal to the axial strain in the toroidal portion of the CVV 11 or 21. This strain is determined by the amount of liquid added to or removed from the inner part of the tube. Each cm of lengthening of the inflatable tube as in Table 1 requires the addition of a volume of hydraulic fluid which depends upon A₁ (1.0 cm²); as hydraulic fluid is introduced into the anisotropic tube which forms the toroidal segment. Given an initial length of the toroidal segmentof 40 cm, this means that each cm³ of liquid put into the toroid will cause a circumference increase around the patient's torso of 1.0%, while the strain in the toroidal segment is equal to 2.5%.

The energy input per cycle is delivered through the movement of the hydraulic fluid into the anisotropic inflatable toroid, which can be visualized as fluid flowing from a low-pressure zone to a high-pressure zone. From an energy analysis point of view, this is equivalent to hydraulic fluid driving the expansion of a hydraulic cylinder with a pressure that varies with extension of the cylinder.

The hydraulic energy supplied by the driver could be based on a gear pump or a movable piston within a hydraulic cylinder driven by an electric device for example. A bellows pump linked to a mechanical driver such as a rack and pinion is an especially good way to drive the motion of hydraulic fluid, because as long as the bellows remains intact there will be no leakage of fluid.

One can visualize this by imagining a plane perpendicular to the fluid flow where the hydraulic fluid enters or leaves the pressurized inflatable tube forming the toroid of FIG. 3. The motion of this hydraulic fluid across this boundary, and its pressure as it moves across the boundary determine the total amount of hydraulic energy delivered to the toroid in each cycle.

Part of this energy is dissipated in each cycle by hysteresis in the elastomer, and part is recoverable as the pressure is released. In the case that the toroid is pressurized using a small hydraulic gear pump, it is even possible to recover some of this energy as electricity to charge the batteries when the flow through the gear pump is reversed. Doing so has the potential to increase battery life substantially.

The inflated toroid will adopt a shape that depends on an equilibrium of forces within the toroid of tubing itself. This shape is determined by the volume of hydraulic fluid contained inside the toroid of tubing, which results in a force F₁ tending to increase the toroidal circumference.

Elastic stress and pressure are at equilibrium when the toroid is still. The hydraulic pressure P₁ inside radius r₂ 62 creates an axial force equal to F₁:

F₁=2*πr₂²*P₁

(There are two sides of the half circle of toroid pushing the two halves of the pressurized toroid apart. We have adopted the convention that forces tending to increase the circumference around the torso are positive and forces tending to reduce the circumference are negative.)

The pressure difference inside minus outside of the toroid P_{diif} creates a force F₂ which is pushing the two halves together in the case that there is a relative vacuum inside the pressurized toroid. This force F₂ is given by:

F₂=A₂*P_{diff} where A₂=(2*r₃+h)*(1+S₁)

The elastic retractile force F₃ in the tube wall is given by:

F₃=2*A₂*S₁*M₂ where A₂=(πr₃²−π₁²),

and the modulus M₁=M₂ applies to the axial direction within the tube wall. The axial strain in the tube wall is S₁, taken as the maximum value of strain during the breathing cycle, 10% in Table 1.

These three forces add up to zero:

F₁+F₂+F₃=0.

FIG. 10 illustrates this force equilibrium for the case of Example 2 which is an actual anisotropic tube created as in FIG. 7.

The hydraulic fluid pressure P₁ 67 inside of r₁ 61 will essentially be at a constant pressure throughout the tube at any moment in time, with only minor differences due to viscous resistance to fluid flow and acceleration of the fluid. That hydraulic pressure will increase during the inhalation portion of the breathing cycle as fluid is introduced into the toroidal segment by the hydraulic driver. For Table 1, and 94 and 98 of FIG. 8, we have assumed a linear increase of hydraulic pressure from zero to its final value at 10% strain.

The pressure within the isotropic elastomeric layer 65 will be nearly the same as the hydraulic fluid pressure at the fluid/elastomer interface at r₁, with a small internal pressure gradient due to the elastic stress as one goes through the elastomer between r₁ 61 to r₂ 62. At r₂, there is a change of the slope of hydraulic pressure versus radius; in the case of a uniformly anisotropic outer portion of the tube wall between r₂ to r₃, the pressure does not go through a sudden change but the slope of the hydraulic pressure versus tube radius curve does change.

However in the case we have created as a simplification, where r₂ is constant, the hydraulic pressure has a step-change at the interface at r₂ between the inner isotropic elastomer layer 65 to the outer anisotropic elastomer layer 66 residing between r₂ to r₃. In this case, from r₂ to r₃, the pressure inside the fiber reinforced elastomer layer is approximately equal to the environmental pressure outside of the tube.

The hydraulic pressure within the tube P₁ 67, inside radius r₂ 62 causes a force in the axial direction of the toroidal tube which actuates the expansion of the vest around the thoracic cavity.

As shown in FIG. 6, modulus M₂ comes out of the plane of the drawing within the outer anisotropic elastomer layer of the tube, 66 and is perpendicular to both the modulus M₃ in the circumferential direction around the tube and the radial modulus M₄. Modulus M₃ is significantly higher than the modulus M₁ in the isotropic elastomer layer 65 or the modulus M₂ in the outer layer of the tube which is aligned with the axial direction of the toroid. In this example M₁=M₂=M₄.

Insofar as the modulus M₃ in the circumferential direction of the outer tube wall between r₂ to r₃ is much higher than the axial modulus M₂, inflation pressure inside the tube will cause the toroid radius r₄ 34 to increase more than the tube's outer radius r₃ 63.

Because of the simplifying assumption of Example 1, that r₂ 62 does not change at all, r₃ 63 will be somewhat reduced during the axial deformation of the tube.

FIG. 10 shows the three component forces applicable to the inflatable toroidal tubes as a function of axial strain S₁ of the tube wall. FIG. 10 is based on actual stress strain data for the anisotropic tube described in Example 2 and shown in FIG. 7.

The secant modulus values used here are so-called engineering moduli, which relate to the original dimensions prior to deformation. The secant moduli used in this calculation are determined by a line from zero stress and zero strain to the stress at 10% strain, as illustrated by 103 of FIG. 9. The upper and lower 10% secant moduli of Table 1 are selected to be characteristic of the upper and lower practical limits of elastomer modulus.

The slope of the line 98 shows the hydraulic pressure versus axial strain of the toroid for the low axial modulus case of M₂ (1.0 MPa) in which P_{diff} goes from 0 to −2500 Pa. The slope of the line 94 shows the internal pressure versus axial strain of the toroid for the high axial modulus case of M₂ (5.0 MPa) in which P_{diff} goes from zero to −5000 Pa. (Per our simplifying assumptions, M₂=M₁).

At zero strain in the tube wall, there is no force contribution from elastic stress in the tube wall. The component of the force due to hydraulic pressure which is maintaining the vacuum F₂ changes slightly with the radius of the toroid r4, which changes with the axial strain in the toroid S₁.

Both the radius r₄ and the circumference around the thoracic cavity increase in direct proportion to the axial strain in the toroidal segment.

In a breathing cycle, the pressure difference between inside the toroid (comprising the torso containing the thoracic cavity) minus outside the toroid P_{diff} normally changes from nearly zero at the end of the exhalation cycle to a maximum negative value of P_{diff} as shown in FIG. 8, lines 94 and 98. Two examples illustrating a realistic range of elastomer modulus in the tube wall are shown in Table 1. Most of the pressure increase due to straining the toroid to a larger circumference is caused by elastic stress in the tube wall for the geometry and modulus range in Table 1.

We measured the circumference increase of the torso surrounding the thoracic cavity for several adult subjects and found the range of circumference increase to be between 1 cm to 4 cm. For the particular 100 cm radius r₄ of Table 1, this implies a circumferential strain between 1-4%. For the preferred types of CVV shown in FIGS. 1 and 2, the actuated portion of the vest's circumference for these CVVs comprise 40% of the total circumference, which means that the axial strain in the toroidal segment comprising features 11 or 21 would be between 2.5% to 10%.

For the particular cases modeled in Table 1 and FIG. 8, that implies a final pressure inside the tube between 0.109 MPa and 0.361 MPa. Hydraulic pressure in the anisotropic tubes depends on the diameter of the tubes. Smaller tubes require higher hydraulic pressure to actuate the breathing motion of the CVV.

The low side estimate of pressure at 10% axial strain (in Table 1) is based on a P_{diff} value of −2500 Pa between inside versus outside the toroid, and a relatively low elastomer modulusof 1.0 MPa. The higher pressure estimate of the hydraulic pressure is based on a P_{diff} value of −5000 Pa and a rubber modulusof 5 MPa.

Table 1 is based on one single point in the inflation curve of two different toroids of anisotropic inflatable tubing at a circumferential strainof 10%, which form one tube which is a part of the actuated portion of a CVV as in FIG. 1 11 or 21 of FIG. 2.

Table 1 also shows the total energy consumed to cause the deformation of a single anisotropic tube as in 94 and 98 of FIG. 8. A stack of 21 such tubes comprises the actuated portion of the CVV, allowing the calculation of the total energy consumed in a single breathing cycle, as shown in Table 1. The power consumption data of Table 1 is an overestimate because we have overestimated the total axial strain needed to enable the CVV breathing cycle.

Example 2

This example demonstrates one way to create anisotropic elastomer tubes which are suitable for the actuated section of a CVV.

FIG. 7 illustrates an anisotropic tube for the CVV application. An extruded silicone elastomer tube was wound with high-modulus string around the outside of the tube, as in FIG. 7, to constrain the radial expansion of the tube as it is pressurized. The string was attached to the silicone tube via a relatively thin layer of moisture curing silicone adhesive.

Experimental: A silicone tube with an inside diameter r₁ of 0.479 and outside diameter r₂ of 0.635 cm was placed onto a polished metal shaft using a talc layer to prevent sticking. A room temperature vulcanizing silicone composition (moisture cure silicone based on hydrolysis of acetate ester groups) was applied to the outside of the tube followed by wrapping a high modulus dental floss around the silicone tube, followed by a final layer of RTV silicone. This tube was placed into an oven for final curing.

The fiber wrapped silicone tubing was prepared as described above, then the actual tubing was cut up to measure stress versus elongation as in FIG. 9. The results of these tests were used to make the specific predictions of FIG. 10 and Table 2, based on the simplifying assumption that r₂ does not change during inflation.

The string which was wrapped around the outside of the tube was near, but not touching the next neighbor string forming the helical winding. The string consists of a multifilament bundle of individual fibers, and the silicone adhesive soaked between those individual fibers to give particularly good adhesion.

The string wraps around the silicone tube at a helix angle defined by the angle between the tube's axis of symmetry and the local axis of symmetry of the fiber helix.

The fiber was wound around the silicone elastomer tube which has an inside radius r₁=0.479 cm and outside radius r₂=0.635 cm. The moisture curing silicone plus the helically wound fiber made the measured outer radius r₃=0.639 cm based on the outer diameter of the helically wound tube.

The helix angle 71 for this fiber is 87.15 degrees at zero strain 70 (where the hydraulic pressure inside the tube 76 is zero). Table 2, Column 4 refers to the pressurized tube shown in 80 in which the helix angle 81 is 86.87 degrees at 10% strain (where the hydraulic pressure inside the tube 86 is 0.152 MPa.

The anisotropic tubing of Example 2 has a 10% secant modulusof 1.91 MPa, as can be seen from FIG. 9, 103; lying between the upper and lower bounds of Table 1 and FIG. 8. FIG. 8 also shows the pressure versus axial strain for two realistic ranges of axial strain of the anisotropic tubing of FIG. 7 forming the toroidal segments comprising either 11 or 21. Data corresponding to the maximum inflation state of tubes during a realistic breathing cycle are shown in columns 4 and 5 of Table 2.

For the purpose of Table 2, we have adopted realistic values for the circumference increase around a human torso during a breathing cycle, and we have adopted a mid-range vacuum pressure −3750 Pa for the maximum value of P_{diff}.

FIG. 9 shows the axial stress strain curve 101 of a piece of helically wound tubing as in FIG. 7. Its measured Young's modulus is 102 (3.24 MPa) and the 10% secant modulus is 103 (1.91 MPa). The stress at 10% strain 104 is 0.191 MPa.

Not shown in FIG. 9, but referenced in Table 2, are the average modulus values between 0 to 3.75% strain and from 3.75% strain to 7.62% strain, as determined from the actual stress values at 3.75% strain and 7.62% strain.

Table 2 uses the model of Example 1 to compare these two different strain ranges for the tube described here in this example and illustrated in FIG. 7.

TABLE 2
Simplified Treatment of Inflatable Hoop Made of Anisotropic Tubing

| | Drawing | (Based on actual stress strain data) | | |
|---|---|---|---|---|
| Symbol | Ref. # | Definition | | |
| | | Strain @ Reference State Based on Dimensions | 3.75% | 3.75% |
| | | Before Inflation | | |
| M₂ | 61 | | 2.96 | 2.51 |
| r₂ | 62 | radius, boundary isotropic/anisotropic layers (cm) | 0.635 | 0.635 |
| P_{diff} | 53, 63 | differential pressure, inside to outside hoop (Pa) | 3750.00 | 3750.00 |
| r₄ | 34 | characteristic undeformed hoop radius (cm) | 15.92 | 15.92 |
| | 51 | Strain Range During Breathing Cycle | 0-3.75% | 3.75-7.64% |
| P₁ | 67 | max hydraulic fluid pressure inside tube (MPa) | 0.23 | 0.29 |
| r₁ | — | radius, boundary between liquid/elastomer | 0.479 | 0.479 |
| r₃ | — | outisde tube radius (cm) | 0.639 | 0.639 |
| h₁ | — | separation between hoops in the vest (cm) | 0.15 | 0.15 |
| F₁ | — | hydraulic force pushing hoop apart (N) | 29.5 | 37.3 |
| F₂ | — | force due to vacuum pulling hoop together | −19.70 | −19.70 |
| F₃ | — | elastic retractile force in both tube walls (N) | −9.78 | −17.57 |
| A₁ | — | cross-sectional area of the tube inside r₂ (cm²) | 1.267 | 1.267 |
| A₂ | — | cross-sectional area of tube wall (cm²) | 0.561 | 0.561 |
| A₃ | | total area perpendicular to deformed hoop + h (cm²) | 50.65 | 50.65 |
| sₘₐₓ | | max strain, low to high indexed to lowest strain | 3.75% | 3.75% |
| | | patient circumference % covered by actuated tubes | 40% | 40% |
| | | cm³ increase in each tube during breathing cycle | 1.900 | 1.900 |
| | | energy (J) per cycle based on PV change in tube | 0.11 | 0.18 |
| | | Elastic strain energy per cycle per loop | 0.664 | 0.564 |
| | | power (W)/tube based on 12 breathing cycles/minute | 0.02 | 0.04 |
| | | number of toroidal segments per vest | 21 | 21 |
| | | power (W) based on number of torodial hoops | 0.45 | 0.74 |
| | | power (W) based on 50% recycling of energy | 0.23 | 0.37 |

Table 2 uses actual dimensions of the sample tube created, and models two different deformations of the anisotropic tubing.

Table 2 and FIG. 8 both show realistic axial deformations from 0-3.75% 93 and from 3.75-7.62% 97 elongation in the axial direction of a toroidal segment comprised of an anisotropic tube made from fiber wound elastomer tubes as in FIG. 7. These strains were selected based on actual measurements of circumferential strain of the torso surrounding the thoracic cavity during a particular person's breathing cycle. The patient was the principal inventor, Roger Faulkner, who requires 24/7 ventilation support due to a paralyzed diaphragm. Table 2 also shows energy consumption data for an entire CVV which contains 21 individual anisotropic toroidal tube segments. Both Table 1 and Table 2 have adjusted the distance between next neighbor anisotropic tubes h1 in the CVV so that the actuated portion of the CVV in both cases is 30.00 cm.

The higher range of hydraulic pressures between 3.75-7.62% will tend to reduce buckling of the toroidal segments, compared to the case where pressure goes to zero at the end of the exhalation cycle.

Operating between 3.75-7.62% strain in the tube wall will also increase the retractile force at the end of the exhalation cycle, which would be useful for some patients needing a relatively high expiratory pressure due to COPD.

Column 4 of Table 2 applies to the deformation 93 of the anisotropic tubes of FIG. 7 through FIG. 10 from 0 to 3.75% strain. Column 5 of Table 2 applies to the deformation 97 from 3.75% to 7.62% engineering strain (equivalent elongationof 3.75% during the inhalation cycle, using 3.75% engineering strain as the starting condition).

Table 2 shows the behavior of a CVV based on anisotropic tubes of FIG. 7, FIG. 9, and FIG. 10. Both Table 1 and Table 2 show energy consumption predictions for a CVV as in FIG. 1 or FIG. 2, comprised of a stack of inflatable tubes forming a vest that is 30 cm high. In Table 1, there are 21 anisotropic tubes stacked up to form the front portion of the CVV whereas in Table 2, there are 20 anisotropic tubes stacked up to form the front portion of the CVV.

The effective differential pressure level at the end of the inhalation cycle P_{diff} in Table 2 is taken to be 3750 Pa; this is halfway between the upper and lower P_{diff} limits of FIG. 8 and Table 1.

Silicone is a desirable material for making prototype anisotropic tubes of the CVV due to the simplicity of bonding helically wound fibers around extruded silicone tubing. There are however other suitable materials for these anisotropic tubes.

Tubes having the needed strength and modulus values can be made from many different elastomer/fiber combinations. The particular design of FIG. 7 can also be created using thermoplastic elastomer tubing wound about with a fiber that has been coated with a compatible thermoplastic elastomer which bonds to both the fiber and the thermoplastic elastomer tube in an annealing process.

Example 2 is based on a 50 Shore A durometer silicone elastomer tube of FIG. 7 and FIG. 9. The fiber was a dental floss, and the adhesive was a moisture cure silicone

FIG. 8 shows hydraulic inflation pressure of the anisotropic tube versus strain in the tube wall from 0-14% strain. In Table 2, an inhalation cycle can either be from 0-3.75% strain in the tube wall 93, or the inhalation cycle can go from 3.75-7.62% strain in the tube wall 97. The hydraulic pressure versus strain curve 93 represents the behavior of a single anisotropic tube of Table 2 between 0 to 3.75% strain. The hydraulic pressure versus strain curve 97 represents the behavior of a single anisotropic tube of Table 2 between 3.75% to 7.62%.

The horizontal axis of FIG. 8 shows the axial strain of the toroidal segment, and the vertical axis shows the pressure inside an anisotropic tube which forms the toroidal segment.

The inflation pressure inside the anisotropic tube is calculated via the balance of forces which must add up to zero, as illustrated by FIG. 10.

The hydraulic pressure Pi increases primarily due to the elastic stress in the tube wall for the particular cases illustrated.

FIG. 10 shows a plot of the three forces between half circular portions (as in FIG. 4) of a complete loop of toroidal anisotropic tube (as in FIG. 3) for an individual inflatable toroid made from a single loop of anisotropic tube.

These three forces are due to the elastic stress in the tube wall F₃ 113, the force arising from the differential pressure between the inside of the toroid and the outside toroid F₂ 112, and the resultant force F₁ 111 from the hydraulic pressure inside the anisotropic tube. The force equilibrium (F₁+F₂+F₃=0) is used to calculate the hydraulic pressures shown in FIG. 8.

The expanding toroidal segment is always in equilibrium with the hydraulic inflation pressure P1 and the differential pressure P_{diff}.

FIG. 8 shows four different breathing cycles. There is a sort of an upper and lower bound on elastomer modulus values, indicated by 94 and 98 corresponding to the results presented in Table 1. Table 1 is based on a large circumferential change during a breathing cycleof 4 cm, larger than is expected.

Between these bounds are realistic data that refer to Table 2 showing two different breathing deformations 93 and 97 in which a 100 cm circumference around the thoracic cavity of a patient increases to 101.5 cm (which implies elongation in the axial direction of the 40 cm long initial state of the toroidal segment by 3.75% compared to the initial axial length of the toroidal segment before the breathing cycle begins), as shown in Table 2.

We adopted a value for the change in circumference around the thoracic cavity during the breathing cycleof 1.5 cm (corresponding to a normal breath for a person with a 100 cm circumference around the thoracic cavity for the toroid).

We calculate the volume change of the hydraulic fluid inside the experimentally prepared anisotropic toroidal segment of tubing to be 1.875 cubic centimeters.

The maximum hydraulic fluid pressure which occurs at the inflation of the anisotropic elastomer tube of FIG. 7 to give the dimensions of Table 2, Column 4 of Table 2 is 0.052 MPa. The maximum hydraulic fluid pressure which occurs at the inflation of the anisotropic elastomer tube of FIG. 7 at 7.62% engineering strain given by Table 2, Column 5 is 0.069 MPa.

In Table 2, 20 tubes are stacked to form an active portion of the vest that is 30 cm high. The total volume of hydraulic fluid moving in and out of the vest is equal to (1.875*20=37.5) cm³. This means that if the hydraulic pressure Pi change for each cycle is 0.052 MPa, each cycle will use 0.11 J/cycle. The equivalent energy used per cycle in which the tube wall strain goes from 3.75% to 7.62% as in column 5 of Table 2 would be 0.18 J. At a typical breathing rate of 12 breaths per minute, this implies a power consumption for the entire vest (containing 20 anisotropic tubes) between 0.45 to 0.74 watts.

Detailed finite element modeling of situations where the curvature of the tube is more complex than a circular form allows the prediction of critical conditions that could lead to buckling.

Column 5 of Table 2 models the situation where the anisotropic elastomer tubes of the CVV do not return all the way to their unstressed state during the exhalation, but rather return to the stressed state at 3.75% elongation. The practical advantage of this breathing cycle is that it helps with expiration, as is needed in some lung conditions such as COPD.

### Example 3

The analytical model of the deformation of the actuated section of a CVV which uses anisotropic inflatable tubes for the lengthening mechanical elements, described fully under Example 1, is used here to evaluate four examples of a CVV with differing anisotropic tube diameters.

Table 3 shows the results of these calculations. As with Table 1 and Table 2, the circumference around the patient is taken to be 100 cm, and the elongation of the circumference during the inhalation cycle is taken to be 1.5 cm. The number of anisotropic inflatable tubes forming the actuated portion of the CVV, as in 11 of FIG. 1 or 21 of FIG. 2 is varied so that the total height of the stack of tubes as per FIG. 5 is 30 cm, the same as in Table 1 and Table 2. The value of hi, the separation between next neighbor tubes, is 20% of the tube diameter.

TABLE 3
Effect of Anisotropic Tube Diameter

| r₂ | radius, boundary isotropic/anisotropic layers (cm) | 0.800 | 0.400 | 0.200 | 0.100 |
|---|---|---|---|---|---|
| P₁ | hydraulic fluid pressure (MPa) | 0.22 | 0.34 | 0.58 | 1.06 |
| Symbol | Definition | | | | |
| r₁ | inside tube radius (cm) | 0.600 | 0.300 | 0.150 | 0.075 |
| | 3.75% Secant Modulus, MPa | 3.00 | 3.00 | 3.00 | 3.00 |
| r₃ | outside tube radius (cm) | 0.8160 | 0.4080 | 0.2040 | 0.1020 |
| r₄ | characteristic undeformed hoop radius (cm) | 15.92 | 15.92 | 15.92 | 15.92 |
| h₁ | separation between hoops in the vest (cm) | 0.33 | 0.16 | 0.08 | 0.04 |
| | Number of tubes to form a 30 cm high CVV | 15.3 | 30.6 | 61.3 | 122.5 |
| P₄ | differential pressure, inside to outside hoop (Pa) | 3.75E+03 | 3.75E+03 | 3.75E+03 | 3.75E+03 |
| F₁ | hydraulic force pushing hoop apart (N) | 44.0 | 17.1 | 7.3 | 3.3 |
| F₂ | force due to Pdiff | −24.25 | −12.13 | −6.06 | −3.03 |
| F₃ | elastic retractile force in both tube walls (N) | −19.79 | −4.95 | −1.24 | −0.31 |
| A₁ | cross-sectional area of the tube inside r₂ (cm²) | 2.01 | 0.50 | 0.13 | 0.03 |
| A₂ | cross-sectional area of tube wall (cm²) | 0.880 | 0.220 | 0.055 | 0.014 |
| A₃ | area perpendicular to hoop at reference strain (cm²) | 64.68 | 32.34 | 16.17 | 8.08 |
| sₘₐₓ | reference strain of inflatable tubes | 3.75% | 3.75% | 3.75% | 3.75% |
| | patient circumference % inflated by actuated tubes | 40% | 40% | 40% | 40% |
| | cm³ increase in tube during breathing cycle | 3.02 | 0.75 | 0.19 | 0.05 |
| | energy (J) per cycle based on PV change in tube | 0.33 | 0.13 | 0.05 | 0.03 |
| | power (W)/tube at 12 breathing cycles/minute | 0.066 | 0.026 | 0.011 | 0.005 |
| | power (W) based on number of tubes per CVV | 1.01 | 0.78 | 0.67 | 0.61 |
| | power (W) based on 50% recycling of elastic energy | 0.79 | 0.56 | 0.45 | 0.39 |

Table 3 shows four different radii r₂ for the pressurized zone inside the anisotropic tubes, 0.8, 0.4, 0.2 and 0.1 cm. Table 3 shows that as the pressurized radius r₂ of the tube is reduced, the inflation pressure inside the tube must increase in order to resist the force due to P_{diff}.

Table 3 shows that the total hydraulic energy needed to create the breathing deformation of the CVV is reduced as the anisotropic tube diameter is reduced. As the tube diameter decreases, the pressure needed to counter the compression due to P_{diff} increases as the cross-sectional area of the tube also decreases. The total volume of liquid that needs to be put into the actuated section of the CVV goes down with (1/r₂)². At the same time, the number of tubes required to form the 30 cm high actuated portion of the vest increases proportional to (1/r₂)².

The net effect is that the energy efficiency of the CVV is increased as smaller diameter, higher pressure anisotropic tubes are used to form the vest.

As smaller tubes are used, the number of tubes needed for the actuated section of the CVV increases, requiring more connections to be made between the hydraulic manifold (such as 16 or 26) and the anisotropic tubes. Those connections are expected to be a primary location of failures, so a CVV with more tubes may be less reliable than a CVV with larger and fewer anisotropic tubes.

One way to look at this would be to pick an optimal hydraulic pressure range for operation of the CVV and then use that pressure to calculate the desired radius of the anisotropic tubes.

Hydraulic pressure used in the CVV must be low enough so that it is not dangerous to the patient in case of a leak; also the higher the pressure the more likely it is that the system will leak and that is a serious problem because it could result in loss of function.

It is possible to create redundant designs, for example, one can have two sets of inflatable tubes either one of which can actuate the motion of the vest. If one of those subsystems fails because it leaks, the other one would still be functional. However, that would not take care of catastrophic damage in which both systems are compromised simultaneously.

The energy use of the CVVs of Table 1 to Table 3 are quite low compared to the energy consumption of a leading commercially available ventilator, the Trilogy 100 from Philips Respironics. The Trilogy 100 consumes about 19 watts in normal operation for a typical patient. In standby mode, it consumes 0.7 amps, 10 watts. That means that the Trilogy 100 is consuming about 9 watts for the actual breathing cycle energy. As can be seen from the last two lines of Table 1, Table 2, and Table 3, the CVV can be operated at significantly lower power.

### DESCRIPTION OF THE FIGURES

FIG. 1 illustrates a desirable implementation of the invention. A torso 10 is surrounded by the CVV consisting of several components. There is a front part of the CVV 11 which contains lengthening mechanical elements which actuate the breathing action of the CVV. On the left side of the CVV, there is a manifold 16 that delivers the power needed to drive the lengthening of the mechanical elements. On the right side of the vest, just beyond the lengthening mechanical elements, there is a closure 17 which can be opened or closed to aid in donning the vest. Said manifold 16 is connected via cables or hoses 15 to the control unit 13. The power needed to drive the lengthening mechanical elements comes from the power unit 14 and can be supplied by a pressurized fluid such as air or hydraulic fluid, or electrical energy. The control unit 13 switches the power on and off to cause the front portion of the vest 11 to expand during the inhalation cycle and to contract during the exhalation cycle. The back side 12 of the vest is composed of a comfortable fabric. The control unit 13 is necessarily electronic in nature and would receive its power from a battery which may be grid-connected. The CVV of FIG. 1 also has a portion of the vest that goes over the shoulders 18. This feature makes it more possible for the person wearing the vest to run for example, by preventing the vest from slipping down on the torso.

The version of the CVV shown in FIG. 1 would not work well for a woman with large breasts. FIG. 2 shows a modified version of the vest that would work better for such a person. FIG. 2 illustrates a desirable implementation of the invention. A torso 20 is surrounded by the CVV consisting of several components. There is a front part of the CVV 21 which contains lengthening mechanical elements which actuate the breathing action of the CVV. On the left side of the CVV, there is a manifold 26 that delivers the power needed to drive the lengthening of the mechanical elements. On the right side of the vest, just beyond the lengthening mechanical elements, there is a closure 27 which can be opened or closed to aid in donning the vest. Said manifold 26 is connected via cables or hoses 25 to the control unit 23. The power needed to drive the lengthening mechanical elements comes from the power unit 24 and can be supplied by a pressurized fluid or electrical energy. The control unit 23 switches the power on and off to cause the front portion of the vest 21 to expand during the inhalation cycle and to contract during the exhalation cycle. The back side of the vest is composed of a comfortable fabric. The energy to drive the inhalation/exhalation cycle comes from the power unit 24 which may be supplying electrical energy or a pressurized fluid through the control unit to the CVV. The control unit 23 is necessarily electronic in nature and would receive its power from a battery which may be grid-connected.

FIG. 3 illustrates a single hoop of anisotropic inflatable tube of a preferred embodiment of the invention. It is a circularly symmetrical hollow tube bent around into a torus. The torus forms a hoop of anisotropic tubing with a pressurized fluid inside the tubing. Radius r₄ 34 of the hoop is defined by the circular path of the center of symmetry of the tube which is bent around into a circular hoop. r₅ 35 is the innermost radius for any part of the hoop. r₆ 36 is the outermost radius for any part of the hoop. The line shown as A-A in FIG. 3 shows the point where the cut in the tubing is made to show the cross-section of FIG. 6.

FIG. 4 shows one half of the hoop of FIG. 3, which has been bisected by a plane that is perpendicular to the circumference of the hoop. FIG. 4 represents one implementation of the actuated portion of a CVV, such as 11 of FIGS. 1 and 21 of FIG. 2, in which the toroidal segment comprising the front part of the CVV covers 50% of the circumference around the patient.

FIG. 5 shows how several inflatable hoops as in FIG. 3 and FIG. 4 can be stacked up to create the movable part of the CVV, 11 of FIG. 1 or 21 of FIG. 2, for example. FIG. 5 shows part of 3 hoops as in FIG. 3 or FIG. 4 from a side view which forms a stack like 11 in FIG. 1 or 21 in FIG. 2. The height of each of the hoops shown is 2*r₃ 53 and between each hoop and its neighbor there is a gap with dimension h₁ 51.

FIG. 6 illustrates the cross-section shown by A-A in FIG. 3. FIG. 6 shows the tube wall in more detail. The tube wall has 2 elastomeric layers, the outermost of which has anisotropic mechanical properties. The inner part of the tube inside of r₁ 61 contains fluid which may be under pressure 67. Between r₁ and r₂ is an isotropic elastomer layer 62. Between r₂ and r₃ is an anisotropic elastomer layer 63 in which the circumferential modulus around the tube M₃ is greater than the axial modulus M₂.

FIG. 7 shows two states of an anisotropic elastomer tube with a helical fiber-reinforcement on the outside. 70 shows the low-pressure 75 state, and 80 shows the high pressure 85 state of the inflation pressure inside the anisotropic tubes. In the low-pressure state 70, the height of the stack of parallel helically-wound fibers is 72 and in the high-pressure state 80, the height of the stack of parallel helically-wound fibers is 82. In the low-pressure 75 state, the helix angle between the inflatable tubes 73 and the axis of symmetry 76 of the tube is 71. In the high-pressure 85 state, the helix angle between the inflatable tubes 83 and the axis of symmetry 86 of the tube is 81. Angle 71 is greater than angle 81; it is desirable that these angles lie between 85 degrees to 90 degrees.

FIG. 8 shows the hydraulic pressure at 10% strain for an elastomer tube with a 10% secant modulusof 1.0 MPa, and a value of P_{diffof} 2500 Pa 91; this is the state modeled in column 4 of Table 1. FIG. 8 shows the hydraulic pressure at 10% strain for an elastomer tube with a 10% secant modulusof 5.0 MPa, and a value P_{diff} of 5000 Pa 95; this is the state modeled in column 5 of Table 1. The hydraulic pressure versus tube wall strain at a constant value of P_{diffof} 2500 Pa for the lower modulus (1.0 MPa) elastomer is 94. The hydraulic pressure versus tube wall strain at a constant value of p diff of 5000 Pa for the higher modulus (5.0 MPa) elastomer is 98. FIG. 8 also shows the pressure versus axial strain 93 between 0 to 3.75% engineering strain, and the pressure versus axial strain 97 for engineering strain between 3.75% to 7.62%, as shown in Table 2.

The pressure versus axial strain curve shown by 93 represents experimental data as shown in more detail in FIG. 9, between 0 to 3.75% strain, with P_{diff} starting at 0, and going to a value corresponding to a hydraulic pressure 67 of 3750 Pa at 3.75% strain. The pressure versus axial strain curve shown by 97 is also based on experimental stress strain data as shown in more detail in FIG. 9, between 3.75% strain up to 7.62% strain, with P_{diff} starting at 0 and going to 3750 Pa at 7.62% strain.

1. Conformal vest ventilator which works by expanding and contracting around the torso via lengthening mechanical elements surrounding the thoracic cavity in such a way as to cause a breathing motion within the human lungs.

2. A conformal vest ventilator of claim 1 which contains two different zones such that the mechanism that expands the thoracic cavity is only on the front part of the vest enabling patients to lie comfortably on their back.

3. The conformal vest ventilator of claim 1 which attaches to the body outside the thoracic cavity by means of a vacuum with a negative pressure between 500-5000 pascals, with higher vacuum potentially occurring during the inhalation of breath.

4. The conformal vest ventilator of claim 1 which adheres to the body through reversible adhesives.

5. The conformal vest ventilator of claim 1 which contains both contracting elements and expanding elements.

6. The conformal vest ventilator of claim 4 in which an adhesive attachment exists between a portion of the torso and a removable Velcro strip so disposed as to link with the expanding mechanism of the conformal ventilator; said Velcro strips are attached to the skin of the person wearing the vest in at least a portion of the chest and or belly area, and said Velcro strips attach to an inner moveable part of the conformal vest ventilator.

7. A conformal vest ventilator of claim 1 in which the lengthening mechanical elements inside the vest which cause the vest to expand comprise anisotropic inflatable tubes so designed that upon pressurization, the tubes lengthen more than they expand in diameter.

8. A conformal vest ventilator of claim 1 in which the lengthening mechanical elements inside the vest which cause the vest to expand comprise a flexible rod extending from an electromagnetic actuator.

9. A conformal vest ventilator of claim 1 in which the lengthening mechanical elements inside the vest which cause the vest to expand or contract comprise magnetostrictive alloys.

10. A conformal vest ventilator of claim 1 in which the lengthening mechanical elements inside the vest which cause the vest to expand or contract are actuated by piezo-electric materials embedded in the lengthening mechanical elements.

11. A conformal vest ventilator of claim 7 in which said inflatable tubes comprise an outer fiber-reinforced elastomer layer, an inner annular layer comprising a soft elastomer, and a hole through the middle through which fluid pressure is controlled.

12. A conformal vest ventilator of claim 3 in which a vacuum pump is used to maintain a nearly constant vacuum level in the zone next to the skin.

13. A conformal vest ventilator of claim 3 in which a gas cushion layer, optionally containing a compressible fabric layer, is compressed during the exhalation cycle during which time air is exhausted through one-way valves, and where said gas cushion layer goes to a partial vacuum during the inhalation cycle, during which expansion of the conformal vest surrounding said gas cushion layer occurs.

14. The conformal vest ventilator of claim 3 in which the low permeability layer required for vacuum sealing around the CVV is comprised of Gortex, Tyvek, or a similar microporous film with controlled gas permeability.

15. The conformal vest ventilator of claim one in which power to actuate the vest comes from batteries.

16. The conformal ventilator of claim 1 in which most of the power to operate the device comes from compressed air.

17. A conformal vest ventilator of claim 7 in which said anisotropic elastomeric tubes are comprised of fiber-reinforced elastomers.

18. A conformal vest ventilator of claim 17 in which said fiber reinforced elastomer comprises a short fiber-reinforced elastomer, optionally a nano fiber-reinforced elastomer in which the fibers are uniaxially oriented in the circumferential direction around said inflatable tube.

19. A conformal vest ventilator of claim 11 in which said outer fiber reinforced layer comprises a helically wound fiber bonded to the outside of the inner isotropic elastomer layer by means of a matrix elastomer which bonds to the nearly isotropic elastomer layer below it.

20. A conformal vest ventilator of claim 19 in which said helically wound fiber is bonded to a silicone elastomer tube by means of a room temperature curing silicone composition.
